(19) United States
(12) Patent Application Publication
(10) Pub. No.: US 2016/0007589 A1
(43) Pub. Date: Jan. 14, 2016

(54) RODENTICIDE COMPOSITION IN THE FORM OF AGGLOMERATED CEREALS AND/OR GRAINS

(71) Applicant: LODI, Grand-Fougeray (FR)

(72) Inventors: ALEXIS LOCKMAN, RENNES (FR); ELODIE MERIADEC, RENNES (FR); MARIE-LAURE BIANNIC, CREVIN (FR)

(21) Appl. No.: 14/770,163

(22) PCT Filed: Feb. 27, 2014
(86) PCT No.: PCT/EP2014/053802

§ 371 Date: Aug. 25, 2015

(30) Foreign Application Priority Data
Feb. 28, 2013 (FR) 1351758

(51) Int. Cl. A01N 25/00; A01N 43/16

(52) U.S. Cl. CPC A01N 25/004; A01N 43/16

(57) ABSTRACT

The invention relates to a rodenticide composition in the form of a cereal bar. The invention relates to a solid rodenticide composition characterized in that it is in the form of agglomerated cereals and/or grains including: 50% to 98% by weight, relative to the total weight of the composition, of at least one cereal and/or of at least one grain, whole or crushed; 2 to 25%, relative to the total weight of the composition, of a binder; 0 to 30%, relative to the total weight of the composition, of plant or animal fat in solid form; 0 to 16%, relative to the total weight of the composition, of at least one additive; and 0.0005% to 6%, relative to the total weight of the composition, of rodenticide poison.

### 1. FIELD OF THE INVENTION

The field of the invention is that of phytosanitary compositions and biocides. More specifically, the invention pertains to a rodent-killer or rodenticide composition that can be used in the food and agriculture sector.

### 2. PRIOR ART

Rodent overpopulation is a danger both in terms of health and economics. Indeed, rodents are carriers of numerous pathogens transmissible to humans and animals, such as plague, dysentery, typhus and leptospirosis. This transmission is done via their fleas, their excreta and their bites

Rodents also attack farm harvests, thus causing considerable economic losses. The damage caused to harvests is of many types: rats pierce bags containing cereals to consume them and soil the harvests with their excreta. The amount of harvests destroyed or soiled by rodents is estimated at 20%.

Through to their propensity to gnaw at wood, pipes and electrical cables, rodents also cause fires and domestic accidents.

Examples of these rodents are the grey mouse (Mus musculus), the black rat (Rattus rattus), the Norwegian rat, the brown rat (Rattus norvegicus), the garden dormouse (Eliomys quercinus), the field mouse (Apodemus sylvaticus), the racoon (Myocastor coypus), the musk rat (Ondrata zybethicus) and the vole (Microtus).

In order to combat the overpopulation of these rodents, the phytosanitary and biocide industry has conceived numerous baits incorporating rodenticide agents. These baits are composed of a base of cereals and food matter impregnated with poison. Known rodenticidal agents include, inter alia, anticoagulants, hypnotic agents, water retention agents, cardiotoxic and cytotoxic agents.

The efficacy of a rodenticide depends on numerous factors. One of the most important factors is the consumption of the bait by the rodent and especially its palatability. The bait indeed needs to be sufficiently attractive for the rodent to prefer to consume it instead of its usual food.

Another major factor to be taken into account in the designing of bait is the choice of rodenticide. It has to be efficacious while at the same time reducing mistrust or suspicion on the part of the rodents. Indeed, rodents are endowed with excellent memories and remember foodstuffs that are dangerous. In addition, they have a highly developed sense of smell which enables them to sense the presence of a poison. Being distrustful, they send out “tasters” and wait for several days to assess the danger of the tested foodstuff. They thus quickly learn to avoid many types of bait, especially those that cause violent death among their fellow rodents.

In the light of these different parameters, the patent application WO2009/047175 describes different compositions for rodenticide bait.

A first example relates to rodenticide cereals that take the form of cereal grains, one or more sorts of grains, and/or cereals, coated or impregnated with an active rodenticide material. Some of these cereals are also coated by a spraying of vegetable or animal oil, which makes them more palatable to rodents. However, rats spread these cereals about or carry them away to store them elsewhere. Now, the random dispersal of this type of bait raises problems of health safety, especially problems of contamination of foodstuffs. For this reason, the HACCP standards prohibit the use of easily dispersible rodenticide cereals. This type of bait is also inadvisable for domestic use, since pets and small children could also accidentally swallow these rodenticide cereals.

For this reason, rodenticides in the block form have been developed. These are made of flour (about 30%) and cereals (about 5%) mixed with paraffin as a binder. However, these blocks have a problem of palatability since the paraffin is used in large quantities to withstand wet surroundings. Now paraffin is unattractive to rodents which therefore leave the bait aside. These baits therefore prove to be less efficacious in combating rodents.

Fresh rodent-killer pastes have been proposed comprising animal or vegetable fats instead of the binder. Although these pastes are more palatable than bars, they are not necessarily preferred by rodents when the competing choices of available food are great and take mainly the form of cereals.

It is therefore necessary to propose rodenticide bait that is palatable as well as efficacious and non-dispersible, in order to efficiently protect foodstuffs from rodents.

### 3. GOALS OF THE INVENTION

The invention is aimed especially at overcoming these drawbacks of the prior art.

More specifically, it is a goal of the invention, in at least one embodiment, to provide a rodenticide composition that is not easily dispersible.

It is another goal of the invention, in at least one embodiment, to implement a rodenticide composition, the palatable quality of which is high enough to encourage the rodent to prefer the bait to its usual food.

### 4. SUMMARY OF THE INVENTION

These goals as well as others that shall appear here below are achieved by means of a rodenticide composition in solid form.

According to the invention, such a composition takes the form of agglomerated cereals and/or grains comprising:
50% to 98%, relative to the total weight of the composition, of at least one cereal and/or at least one grain in whole or crushed form,
2% to 25%, relative to the total weight of the composition, of binder,
0% to 30%, relative to the total weight of the composition, of vegetable or animal fats in solid form,
0% to 16%, relative to the total weight of the composition, of at least one additive, and
0.0005% to 6%, relative to the total weight of the composition, of rodenticide poison.

The term “in the form of agglomerated cereals and/or grains” is understood to mean a composition of which at least 50% of the mass comprises whole or crushed cereals and/or grains from plants, the cereals and/or grains being kept together to form a solid unit by means of an edible and palatable binder. The composition of the invention could take several shapes: cuboid, parallelepiped, cylindrical, spherical, pyramidal, etc. The shape of the composition of the invention could include ridges in order to make the bait easier to grasp by the rodent.

Such a rodenticide composition takes the form of an agglomerate of cereals and/or grains, therefore having the two-fold advantage of being particularly palatable to rodents and of being dispersible, thus enabling its use universally and especially in the food and agricultural sector.

Besides, through the use of cereals and/or grains in whole or crushed form and not in the form of flour, the rodenticide bait of the invention is closer to the usual food of rodents. It is therefore more palatable or appetizing. The term “crushed” is understood to mean that the grain can be broken into several pieces without being reduced to powder as in the case of flour. According to the invention, the rodenticide composition does not include flour. Indeed, although flour is a source of food appreciated by rodents, its presence makes the composition more crumbly. A great quantity of binder therefore needs to be incorporated. This reduces the palatability of the bait and amounts to producing bait in the form of a soft paste. Now, the value of such a rodenticide composition that is not in the form of a soft paste and comprises at least 50% of cereals and/or grains in whole or crushed form is that it is closer to the natural food of the rodent and enables it to file its incisors.

Moreover, cereals and grains in whole or crushed form enable rodents to file their incisors which are also called gnawing teeth.

The absence of paraffin overcomes the problem of palatability posed by blocks. The high cereal content by mass makes the bait more palatable to rodents. In being more palatable, the bait is consumed to a greater extent and is therefore more efficacious.

The packaging of the bait in the form of a bar of cereals makes it less easily dispersible than rodenticide cereals. As a consequence, the risks related to the dispersal of the bait in areas storing foodstuffs are eliminated or at least greatly reduced.

In other words, the composition of the invention has the advantages of dispersible cereals and of the paraffin-bound block while at the same time eliminating their drawbacks.

The percentage by weight relative to the total weight of the composition of a constituent A can be computed as follows: (mass A/total mass of the composition)×100.

Preferably, the rodenticide is incorporated into the composition according to the invention in non-coated or non-encapsulated form.

Advantageously, the rodenticide poison is an anticoagulant chosen from the group constituted by difethialone, coumatetralyl, flocoumafen, warfarin, warfarin sodium, chlorophacinone, brodifacoum, bromadiolone and difenacoum, preferably bromadiolone.

In another advantageous embodiment, the rodenticide poison is chosen from among the hypnotic agents and the hepatotoxic agents. Examples that can be cited are the hypnotic poison alpha-chloralose. Another example is the hepatotoxic poison diazepam.

Anticoagulants are inhibitors of vitamin K, which is a key molecule in the coagulation cascade. These agents act by blocking coagulation and making the capillary veins more fragile. Internal bleeding occurs. They are particularly lethal among rodents whose blood volume is low and whose heart rate is high. They are slow-acting agents and require regular consumption of the bait before causing death in the rodent. This slow action limits the phenomenon of distrust among the pests while allowing sufficient time for action in the event of accidental poisoning.

There are known anticoagulants such as warfarin and pindone which are called first-generation anticoagulants. Second-generation and third-generation anticoagulants such as derivates of 4-hydroxycoumarin (brodifacoum, bromadiolone, difenacoum) classified as T+ and N by Regulation 1272/2008, can be efficacious when taken for the very first time. They cause death only after some days. This is a period too lengthy for the rodent to be able to establish a link with the ingestion of the bait.

In one advantageous embodiment, said at least one cereal and/or at least one grain is chosen from the group constituted by millet, oats, rice, maize, wheat, sunflower, sesame, linseed, poppy seed, oat flakes, and their combinations.

The high cereal content makes the bait particularly palatable to rodents. These cereals especially are highly appreciated by rodents. As a result, the bait is consumed to a greater extent by the rodents and is therefore more efficacious.

The cereals can be integrated either in whole form as oat flakes as well as in the form of whole or crushed grains. Rodents are indeed more attracted to cereals in the form of grains or broken grains because this form is closer to their natural food than flour.

The presence of wax and fats makes it possible to bind the whole or crushed cereal grains together to shape them and keep them attached together. Thus, the dispersal and scattering of the cereals by rodents is prevented. In addition, these ingredients are chosen on the one hand to facilitate the industrial-scale manufacture of the rodenticide composition and, on the other hand, to increase the palatability of the bait.

In addition, these elements make it possible to place the bait also in wet places, like bars and unlike rodenticide cereals which poorly withstand moisture.

In another advantageous embodiment, the dried fruit can be chosen from among raisins, dried apricots and dehydrated apples.

The dried fruit is incorporated into the composition in the form of pieces, in order to facilitate its consumption by rodents and enable the industrial-scale preparation of the composition according to the invention.

The composition according to the invention could also include pieces of peanuts.

Advantageously, said at least one additive is chosen from the group constituted by preserving agents, coloring agents, flavoring agents, palatable agents and bittering agents.

It can also contain at least one preserving agent. The presence of preserving agents is necessary to protect the bait for as long as possible from rancidity and the growth of molds, which is inevitable when a foodstuff is exposed to prolonged conditions of moisture. Preferably, the preserving agent or agents are incorporated into the food base in a quantity lower than or equal to 0.2% by weight. Examples of such agents are for example sorbic acid, citric acid, butylhydroxytoluene (BHT), potassium sorbate, nitrates, antioxidants used in the food industry and parabens.

The incorporation of at least one additional palatable agent makes it possible to attract the rodent even more and make it prefer the bait to its usual food, despite its natural attitude of mistrust. The cereals fulfill the role of palatable agents by their nature as foods. It is possible however to add other agents to increase the attractiveness of the bait. Examples that can be cited are cumin, boiled beef, hazelnut extract, carrot flavoring, sugar, cheese and olive oil. In one particularly advantageous embodiment, the bait contains at least one palatable agent. The choice of palatable agent or the association of palatable agents depends on the rodent being targeted.

The base also contains at least one bittering agent for purposes of safety. The presence of a bittering agent is aimed at repelling animals not targeted by the bait or again at causing infants to spit it out. An example of a bittering agent is denatonium benzoate.

It is also important that the additives entering the composition of the food base should be inoffensive to human beings. Indeed, in case of accidental swallowing, the treatment should concentrate only on the elimination of the poison from the human or animal organism and not on the elimination of the various constituents.

Advantageously, the binder is chosen from among a vegetable wax, cocoa butter, animal wax or mineral wax with the exception of paraffin.

Although it is a vegetable fat, cocoa butter can serve both as a binder and as a palatable element.

Examples of such constituent elements are vegetable, animal or mineral wax appropriate to the implementing of the invention, microcrystalline wax, carnauba wax, beeswax and candelilla wax, etc.

However, the use of paraffin is not desirable. Indeed, it has been observed that, although paraffin is a highly economical and efficacious binder, it is not palatable to rodents. Bars including paraffin are left uneaten by rodents because tastier alternatives can be found, especially in places used for storing foodstuffs. As a consequence, as understood in this invention, the rodenticide composition does not include paraffin.

Preferably, the binder content ranges from 2% to 15%, and preferably from 2% to 10% by weight as compared with the total weight of the composition.

Preferably, the vegetable or animal fat is chosen from among tallow, lard, butter, palm oil, corn oil, etc.

These vegetable or animal fats are highly appreciated by rodents and contribute to making the bait more palatable. As a consequence, the composition according to the invention is preferred to foodstuffs or to other baits.

Advantageously, these animal or vegetable fats can be incorporated in solid form, making it possible to shape the baits according to the invention more easily and to bind the cereals and/or grains together.

In one advantageous embodiment, the composition of the invention comprises 50% to 90% by weight of cereals and/or grains in the form of whole or crushed grains, preferably 50% to 75% by weight and even more preferably 60% to 70% by weight.

An object of the invention is also the use of rodenticide composition in the form of agglomerated cereals and/or grains to combat harmful rodents.

In particular, this use can be done for example by placing the composition of the invention at strategic positions in the place to be protected from the presence of rodents (silos, houses, cellars, depots, etc.).

The process can also be done in two steps:
in a first step, a poison-free bait (a placebo) according to the invention is placed, making it possible to allay the mistrust of the rodents and to habituate them to consuming the bait;
then the rodenticide bait is made available.

### 5. LIST OF FIGURES

Other features and advantages of the invention shall appear more clearly from the following description of a preferred embodiment, given by way of a simple, illustratory and non-exhaustive example, and from the appended drawings, of which:

FIG. 1 is a graph presenting the results of trials comparing the consumption of rodenticide compositions in the form of agglomerated cereals and/or grains according to the invention as compared with that of a rodenticide bar.

FIG. 2 is a graph presenting the results of trials comparing the consumption of rodenticide compositions in the form of agglomerated bars of cereals and/or grains according to the invention as compared with that of rodenticide pastes.

### 6. EMBODIMENTS OF THE INVENTION

Other characteristics and advantages of the invention shall appear more clearly from the following description. The general principle of the invention relies on the formulation of a rodenticide composition that is both particularly palatable to rodents in order to maximize its consumption and therefore to maximize the efficiency of the combat against harmful rodents, and also non-dispersible to comply the prevailing standards in the food and agriculture sector.

The examples of embodiments are indicated by way of an illustration and in no way limit the scope of the present invention.

### 6.1 Manufacture of a Rodenticide Composition According to the Invention

The rodenticide compositions according to the invention can be produced by various methods well known to those skilled in the art.

Briefly, the ingredients are mixed together and then the preparation is put through a shaping step and then packaged either loose in a tub or bagged and arranged in boxes.

### 6.2 Examples of Rodenticide Compositions in the Form of Agglomerated Cereals According to the Invention

Different rodenticide compositions according to the invention are prepared in the form of cereal bars according to the method described under point 6.1.

TABLE 1
Composition of a rodenticide bait in the form of agglomerated cereals
and/or grains (example 1)

| | Percentage by | |
|---|---|---|
| Ingredient | mass (%) | Function |
| Wheat grain | qs. 100% | Palatable element |
| Millet grain | 20 | Palatable element |
| Sesame seed | 20 | Palatable element |
| Wax | 30 | Binder |
| Bittering agent | 0.001 | Safety bittering agent |
| Bromadiolone | 0.005 | Rodenticide agent |
| Sugar | 5 | Palatable agent |
| BHT | 0.02 | Preserving agent |
| Coloring agent | 0.25 | Coloring agent |

It can be noted that this composition can also contain different additives such as one or more preserving agents, a safety bittering agent, at least one coloring and/or flavoring agent. It is usual for those skilled in the art to adapt the nature and proportions of such additives according to the preferences of the targeted rodent and conditions of use and storage.

TABLE 2
Composition of a rodenticide bait in the form of agglomerated cereals
and/or grains (example 2)

| | Percentage by | |
|---|---|---|
| Ingredient | mass (%) | Function |
| Wheat cereals | qs. 100% | Palatable element |
| Sunflower seeds | 15 | Palatable element |
| Brown raisins | 10 | Palatable element |
| Cocoa butter | 20 | Binder and palatable |
| | | element |
| Vegetable fat | 25 | Vegetable fat, palatable |
| | | element |
| Bromadiolone | 0.005 | Rodenticidal active principle |
| Coffee flavoring | 4.5 | Palatable agent |
| BHT | 0.02 | Preserving agent |
| Coloring agent | 0.25 | Coloring agent |

TABLE 3
Rodenticide composition according to the invention in the form of
agglomerated cereals and/or grains (example 3)

| | Percentage by | |
|---|---|---|
| Ingredient | mass (%) | Function |
| Wheat cereals | qs. 100% | Palatable element |
| Crushed peanuts | 5 | Palatable element |
| Brown linseed | 10 | Palatable element |
| Millet cereals | 10 | Palatable element |
| Cocoa butter | 3 | Binder and palatable agent |
| Animal fat | 7 | Animal fat, palatable agent |
| Bromadiolone | 0.005 | Rodenticidal active principle |
| Molasses | 4.5 | Palatable agent |
| BHT | 0.2 | Preserving agent |
| Coloring agent | 0.25 | Coloring agent |

TABLE 4
Rodenticide composition according to the invention in the form of
agglomerated cereals and/or grains (example 4)

| | Percentage by | |
|---|---|---|
| Ingredient | mass (%) | Function |
| Wheat cereals | qs. 100% | Palatable element |
| Oat flakes | 5 | Palatable element |
| Gray poppy seed | 10 | Palatable element |
| Sesame seed | 10 | Palatable element |
| Vegetable wax | 22 | Binder element |
| Vegetable fat | 23 | Vegetable fat, palatable |
| | | element |
| Bromadiolone | 0.005 | Rodenticidal active agent |
| Honey | 4.5 | Palatable agent |
| BHT | 0.2 | Preserving agent |
| Coloring agent | 0.25 | Coloring agent |

### 6.3 Comparative Trials of Palatability

Trials were conducted to compare the consumption by rodents of different rodenticide baits used to date with that of the composition according to the invention, in the form of agglomerated cereals and/or grains. More specifically, these trials were used to determine the relative palatability of each bait for the targeted rodents.

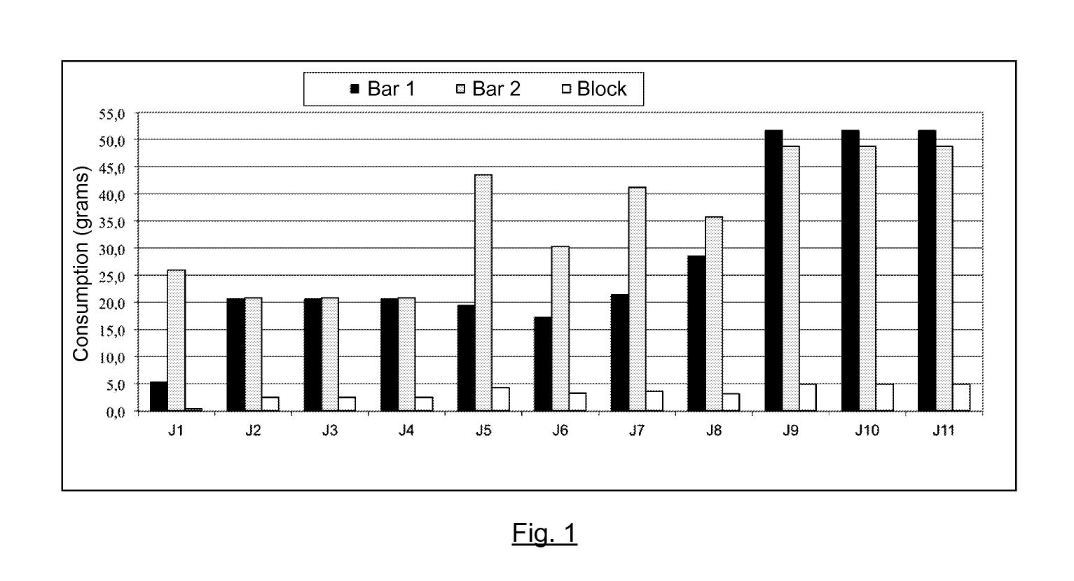

The first series of trials consisted in comparing the consumption of the rodenticide composition according to the invention in the form of bars (bar 1 and bar 2) with the consumption of a classic rodenticide block formed especially by about 30% of a mixture of wheat flour and cereals and 35% of paraffin. The first rodenticide bar according to the invention corresponds to the formula indicated in Table 2, the second to that of Table 1. More specifically, each bait was made available to the rodents for 11 days. The baits were changed every day. The quantity of bait consumed by the rodents was determined daily by weighing the bait after consumption and deducing therefrom the mass of bait consumed. The results of this study are presented in FIG. 1.

It can be noted that the rodenticide compositions according to the invention are substantially more consumed and preferred by rodents than the blocks based on wheat and paraffin. This is due to the presence of paraffin which, while it is a good binder, is not palatable to rodents. In addition, although flour is a foodstuff normally appreciated by rodents, they prefer to consume bait comprising cereals and grains in whole or broken form, which enables them to file their incisors.

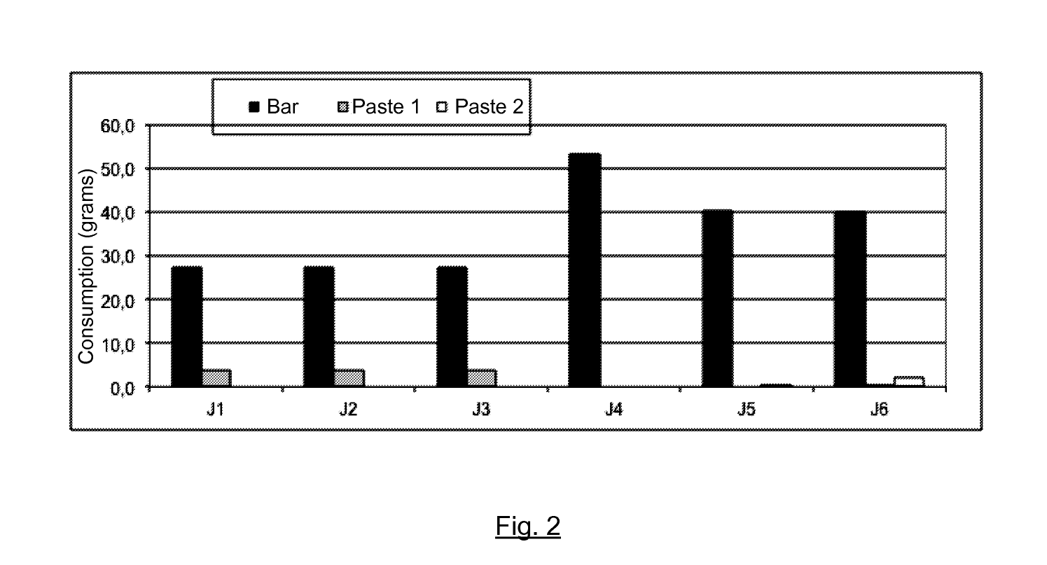

The second study, in the same way, consisted in offering the rodents a rodenticide composition according to the invention presented in the form of a bar, and two different fresh pastes (paste 1 and paste 2). Each of these pastes was composed of about 70% of a mixture of flour and 25% of fat. The quantity consumed of each bait was read and noted daily. The results are shown in FIG. 2.

As can be seen from this graph, the bar is preferred to fresh pastes which the rodents either do not consume or consume in small quantities. On an average, the rodenticide composition according to the invention represents 88% to 100% of the daily consumption of the rodents, the pastes being then left aside uneaten or being consumed in smaller measure (0% to 12% for paste 1 and 0% to 4.5% for paste 2). In other words, the rodenticide composition of the invention, in the form of agglomerated cereals and/or grains, is consumed seven to ten times more than fresh paste.

The rodenticide composition of the invention in the form of agglomerated cereal and/or grain bars is therefore more palatable than the existing rodenticide bait. It is indeed more efficacious in combating rodents.

### 7. CONCLUSION

The present invention therefore resolves both problems of dispersible quality posed by rodenticide cereals and problems of palatability posed by blocks and fresh pastes. In other words, the composition according to the invention has the advantage of dispersible cereals and blocks while eliminating their respective drawbacks.

As can be noted, in the light of the comparative results of the trials presented in FIGS. 1 and 2, the rodenticide composition of the invention, in the form of agglomerated cereals and/or grains, is appreciably more palatable than existing baits in the form of blocks and/or fresh paste. Now, the bait is all the more efficacious as it is consumed by the targeted rodents.

Owing their solid appearance, the rodenticide cereal bars of the invention are difficult to disperse by the rodents. As a consequence, the risk of dissemination and involuntary poisoning are greatly limited.

In addition, binder elements such as wax or cocoa butter are used firstly to keep the cereals and/or grains together to make them a non-dispersible bait and secondly to make the composition of the invention better suited to moist places.

Finally, owing to its palatability and non-dispersible character, the rodenticide composition of the invention is especially suited to use in the food and agriculture sector and in domestic places.

1. Solid rodenticide composition characterized in that it takes the form of agglomerated cereals and/or grains comprising:
50% to 98%, relative to the total weight of the composition, of at least one cereal and/or at least one grain in whole or crushed form,
2% to 25%, relative to the total weight of the composition, of binder,
0% to 30%, relative to the total weight of the composition, of vegetable or animal fats in solid form,
0% to 16%, relative to the total weight of the composition, of at least one additive, and
0.0005% to 6%, relative to the total weight of the composition, of rodenticide poison.

2. Composition according to claim 1 wherein the rodenticide poison is an anticoagulant chosen from the group constituted by brodifacoum, bromadiolone and difenacoum, difethialone, coumatetralyl, flocoumafen, warfarin, warfarin sodium, chlorophacinone, preferably bromadiolone.

3. Composition according to claim 1 wherein the rodenticide poison is chosen from among the hypnotic agents and the hepatotoxic agents.

4. Composition according to claim 1 wherein the rodenticide poison is not encapsulated.

5. Composition according to claim 1 wherein the cereal in the form of grain or broken cereal is chosen from the group constituted by millet, oats, rice, maize, wheat, sunflower, sesame, linseed, poppy seed, oat flakes, and their combinations.

6. Composition according to claim 1 wherein the at least one additive is chosen from the group constituted by preserving agents, anti-oxidants, coloring agents, flavoring agents, palatability agents, dried fruit and bittering agents.

7. Composition according to claim 6 wherein the dried fruit is chosen from among raisins, dried apricots and dehydrated apples.

8. Composition according to claim 1 wherein the binder is chosen from among a vegetable wax, cocoa butter, an animal wax and a mineral wax with the exception of paraffin.

9. Composition according to claim 1 wherein the vegetable or animal fat is chosen from among tallow, lard, butter, palm oil and corn oil.

10. Composition according to claim 1 comprising 50% to 90% by weight of whole or crushed cereals and/or grains, preferably 50% to 75% by weight and even more preferably 60% to 70% by weight.
